(19) United States
(12) Patent Application Publication
(10) Pub. No.: US 2016/0206907 A1
(43) Pub. Date: Jul. 21, 2016

(54) Corrosion Inhibitor System and Methods for Dry Fire Sprinklers

(71) Applicant: Huguenot Laboratories, Inc., Port Jervis, NY (US)

(72) Inventors: Richard O'Leary, Port Jervis, NY (US); William J. Giunco, JR., Manasquan, NJ (US)

(73) Assignee: Huguenot Laboratories, Inc., Port Jervis, NY (US)

(21) Appl. No.: 14/997,394

(22) Filed: Jan. 15, 2016

Related U.S. Application Data
(60) Provisional application No. 62/103,770, filed on Jan. 15, 2015.

(51) Int. Cl. A62C 35/68; A62C 35/62

(52) U.S. Cl. CPC A62C 35/68; A62C 35/62

(57) ABSTRACT

The present invention generally relates to the field of dry fire sprinkler systems, and more particularly, to a filtration device within the system to prevent vent corrosion. A chemical inhibitor or dessicant inhibitor is vaporized and circulated through a dry fire sprinkler system. The systems and methods of the present invention reduce or eliminate corrosion that typically affects conventional dry fire sprinkler systems, such as those caused by oxygen and microbiological systems, which can compromise the function of the fire protection system.

### CROSS-REFERENCE TO RELATED APPLICATIONS

This application claims the benefit of U.S. Provisional Application No. 62/103,770 filed on Jan. 15, 2015, the entire disclosure of which is expressly incorporated herein by reference.

### BACKGROUND

1. Field

The present disclosure generally relates to the field of dry fire sprinkler systems, and more particularly, to a corrosion inhibitor system and method for a dry fire sprinkler system.

2. Related Art

Wet fire sprinkler systems are commonly known in the art and include fluid flow lines that are pre-filled with water. Water is retained in the sprinkler grid by the valves in the sprinkler heads. Once the sprinkler head opens, the water immediately flows out.

In contrast, dry fire sprinkler systems do not include low lines of pre-filled water. Rather, a dry sprinkler system includes a sprinkler grid having a plurality of sprinkler heads, filled before use with air, and/or other gas. The flow lines may be coupled to a pressurized water system and on activation, water flows into the system and out the open sprinkler heads.

Piping and over meta systems in contact with water, air, or other chemicals are often subject chemical corrosion where the metal contacts substances that can cause a reaction altering the chemical structure of the metal. The most well known type of corrosion of metal is rust, i.e. the oxidation of iron.

In addition to chemical corrosion, corrosion can also be caused by microbial growth on the metal which is often referred to as MIC (Microbiological Influenced Corrosion). MIC generally causes localized and pitting corrosion which can be hard to detect in a dry fire sprinkler system until the fire sprinkler system fails.

In fire sprinkler protection systems, treatment of the internal surface of the pipe, which is often not readily accessible once the system is installed, can be difficult. In the past, dry systems have been filled with Nitrogen gas to prevent corrosion, but this is very expensive.

Accordingly, there is a need for a cost effective system for preventing corrosion of the systems.

### SUMMARY

A system and method for inhibiting corrosion in dry fire sprinkler systems includes vaporizing a chemical inhibitor after passing air through a desiccant and delivering it throughout the dry fire sprinkler system. The corrosion inhibitor composition may be saturated onto filter media housed in chamber of a filter feeder apparatus and may be circulated throughout the dry fire sprinkler system in the absence of humidity. The vapors of the corrosion inhibitor composition coat the internal surface of the components of the dry fire sprinkler system to maintain integrity of the components.

### BRIEF DESCRIPTION OF THE DRAWINGS

The foregoing features will be apparent from the following Detailed Description, taken in connection with the accompanying drawings, in which:

FIG. 1 is an exemplary schematic of the corrosion inhibitor system for a dry fire sprinkler system.

FIGS. 2A-2B are views of chemical filter feeder shown in FIG. 1.

FIGS. 3A, 2B and 3C other aspect of the chemical filter feeder apparatus.

FIGS. 4A, 4B and 4C show filter media for the filter feeder apparatus.

FIG. 5 shows a schema another aspect of the corrosion inhibitor system for a dry fire sprinkler system.

### DETAILED DESCRIPTION

A system for preventing corrosion in a dry fire sprinkler system (dry FSS) is disclosed. This system offers several advantages over conventional dry FSS treatment systems by utilizing chemicals, instead of foams, salts, gasses, and other treatments known in the art. By treating these systems with chemicals, the present invention protects and maintains the longevity of the dry FSS, preventing damage to the dry FSS system and enhancing the operation characteristics of the dry FSS system.

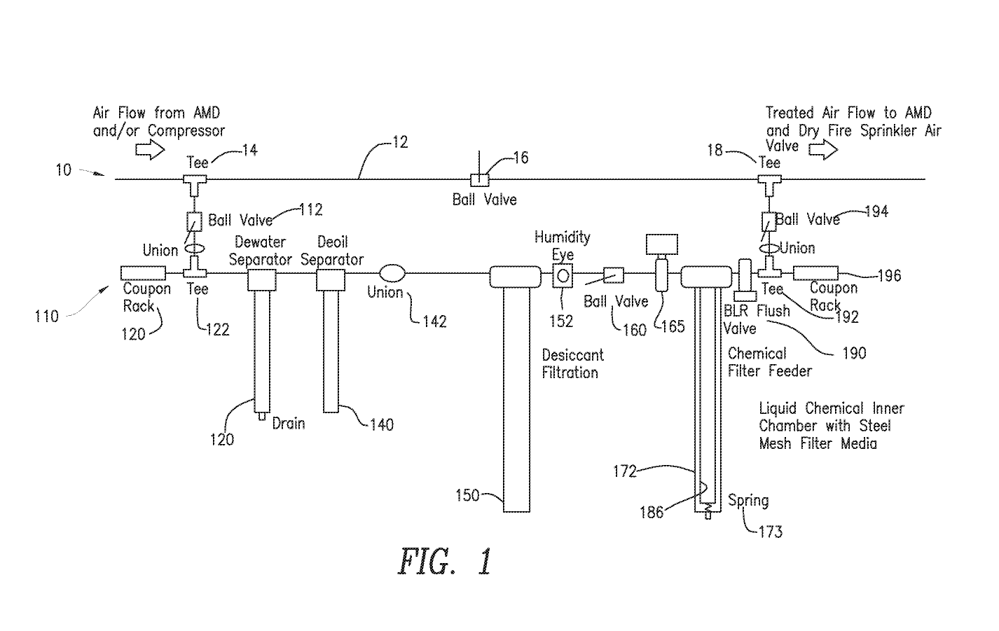

Referring to FIG. 1, dry fire sprinkler system 10 includes main line pipe 12, branch line pipes (not shown), drip leg pipes (not shown), sprinkler head pipes (not shown), etc. Dry fire sprinkler system 10 includes an air compress (not shown), first tee 14, input ball valve 16 and second tee 18. The remainder of the dry sprinkler system 10 is of a conventional configuration and is not shown.

Interconnected with the dry fire sprinkler system 10 is corrosion inhibitor system 110. The corrosion inhibitor system 110 is interconnected with the fire sprinkler system 10 at first tee 14 through ball valve 112 and third tee 122. The corrosion inhibitor system 110 includes coupon rack 120 before the third tee 122, and after the ball valve 112, includes dewater separator 130, deoil separator (or oil coalescing filter) 140, union 142, desiccant filtration apparatus 150, humidity eye 152, filtration ball valve 160, fill valve 165, filter feeder apparatus 170, flush valve 190, fourth tee 192, output ball valve 194 and second coupon rack 196. The corrosion inhibitor system 110 is connected back to the fire sprinkler system 10 at second tee 18.

Air from air compressor (not shown) in the dry fire sprinkler system 10 enters the corrosion inhibitor 110 where it goes into corrosion coupon rack 120 which can record corrosion by loss of weight. The air then goes through dewater separator 130 which can include a centrifuge to remove water vapor from the air. The dry air then goes through deoil separator 140 where any oils, such as oils from the compressor, are removed from the air to protect the desiccant from interacting with trace amounts of oil in the air. Next, the air flows through desiccant filtration apparatus 150 where the air flows through desiccant and loses moisture. Thereafter, the air flows through the humidity eye 152. The humidity eye 152 indicates when the desiccant is used up. The humidity eye can be treated paper having a surface containing cobalt chloride which indicates when the air does not include any moisture, allowing improved absorption for chemicals. Ball valve 160 allows for shutting the corrosion inhibitor system 110 to change/reload desiccant filtration apparatus 150.

After the air flows through chemical filter feeder 170 the air and chemicals are broken into small bubbles, for maximizing contact of the chemical inhibitor to the surfaces of the air particles, before entering the dry fire sprinkler system 10. Essentially, the air flow is disrupted to turbulent flow through the chemicals, and the chemicals are dispersed on one or more filters to maximize contact with air to create an aerosol-like flow. After leaving the chemical filter feeder 170, the air and chemicals flows through BLR flush valve 190 to flush out chemicals and then flows to coupon rack 196 and through fourth tee 192 and ball valve 194 into the dry fire sprinkler system 10.

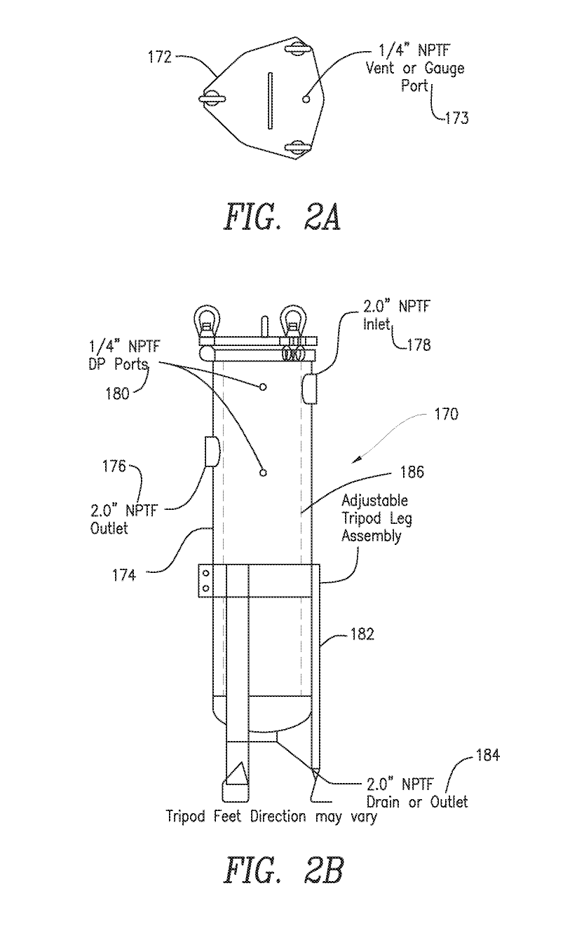

Referring now to FIGS. 2A and 2B, the filter feeder apparatus 170 is shown. A top 172, shown in FIG. 2A, may include gauge port 173. The apparatus 170 further includes outer body 174, outlet 176, inlet 178, ports 180, optional stand 182, and drain 184. Apparatus 170 also includes inner body 186. The filter apparatus 170 could be any suitable size, such as, for example, a tube approximately three feet long.

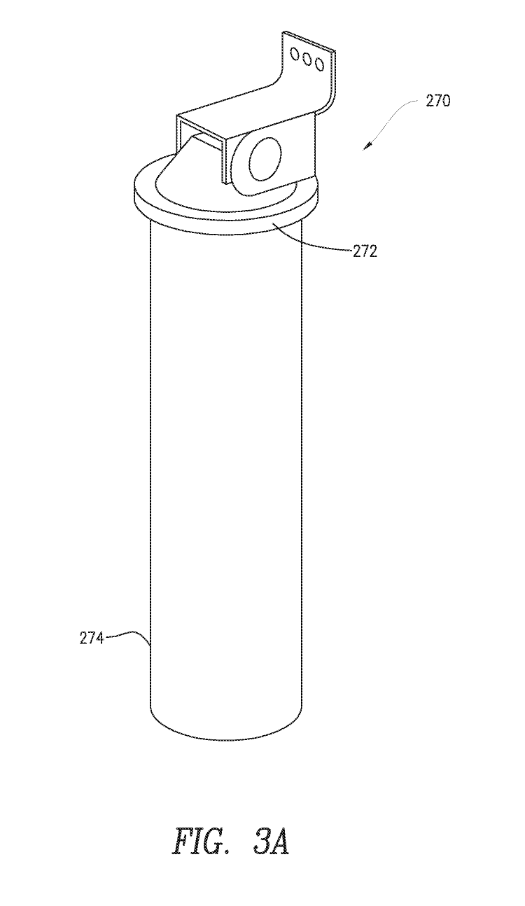

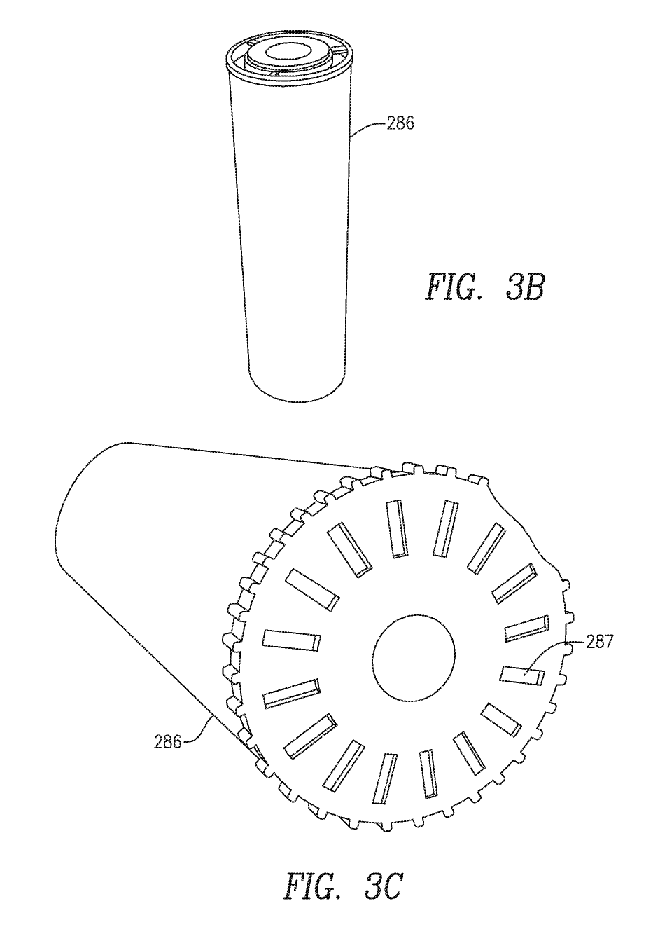

FIGS. 3A, 3B and 3C show another aspect of the filter feeder apparatus 270. The apparatus 270 includes an outer body 274 and a top 272. As shown in FIG. 3B, apparatus 270 also includes an inner body 286. As shown in FIG. 3C, the bottom of the inner body 286 includes a plurality of apertures 287 for fluid flow.

Referring to FIGS. 2A, 2B, 3A, 3B and 3C, as well as FIG. 1, it can be seen that chemical filter feeder 170, 270 includes an inner chamber 186, 286 that can be supported within outer body 172, 272, by spring 173 which pushes inner body 186, 286 up against air o-ring at the upper end of inner body 186, 286 to seal the upper end of the inner body 186, 286 at an up end. The inner chamber 176, 286 houses a steel mesh filter media and a liquid chemical. The dried air enters the apparatus 170, 270 at an upper end, flows down the sides of the inner chamber 186, 286 to the bottom and then flows s back up through apertures 287 into the inner chamber 186, 286 pushing through the liquid chemical and filter media to pick up chemical vapors.

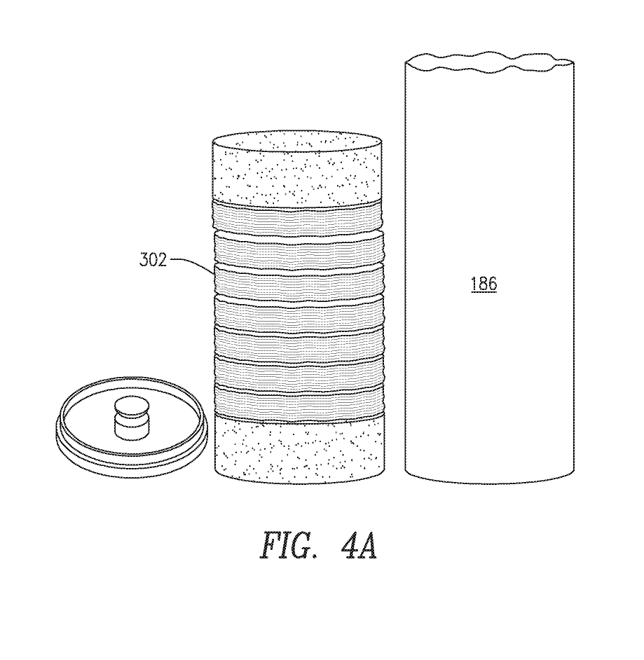

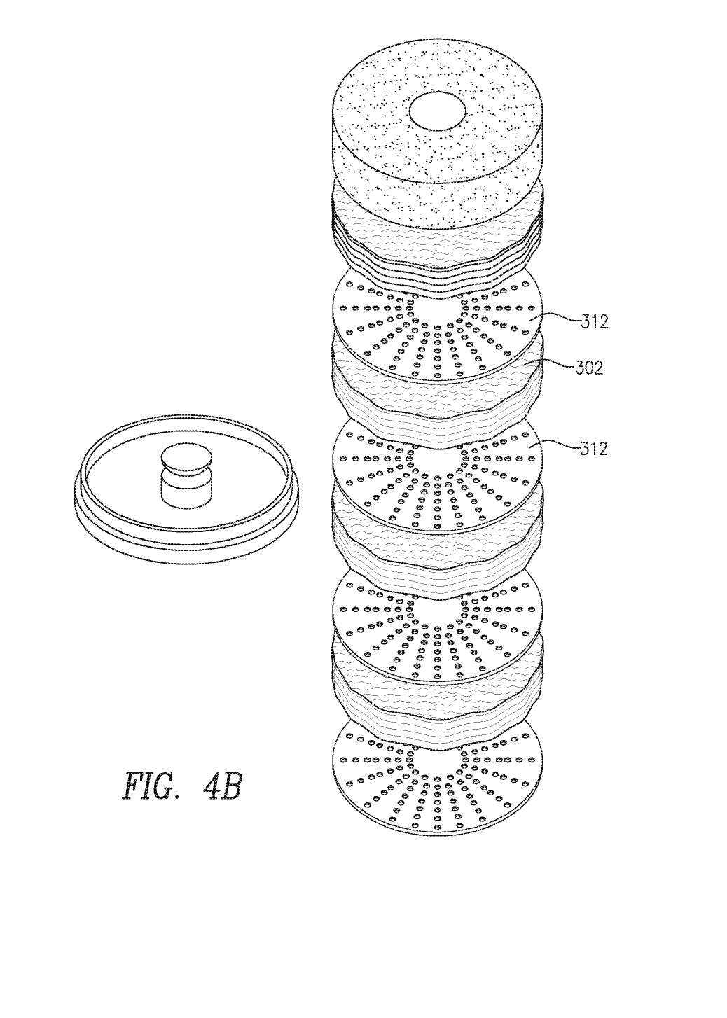

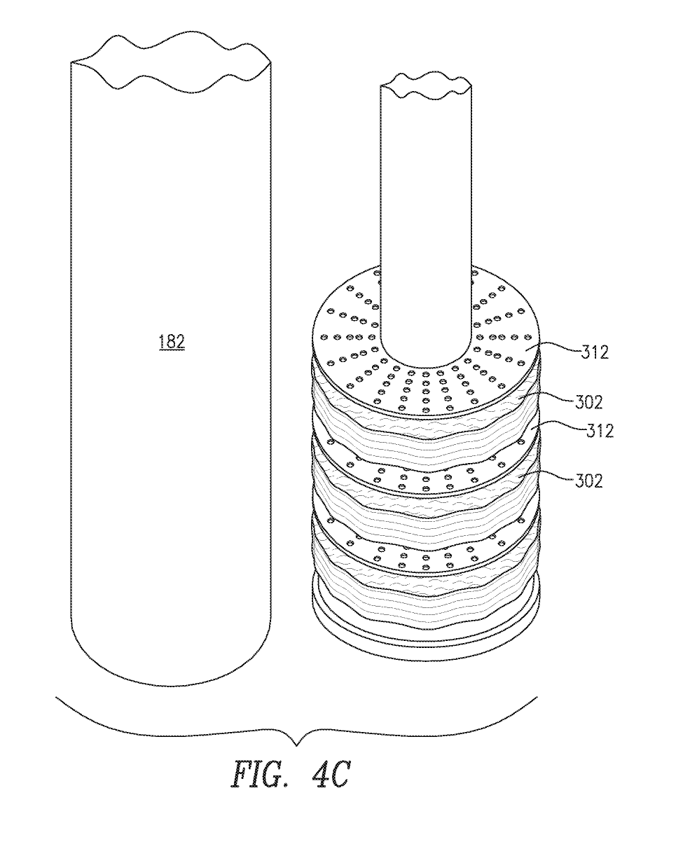

FIGS. 4A, 4B and 4C show filter media for use in inner body 186. As shown the filter medium, is contained within the inner body 186 through which the compressed air flows, absorbing chemical product ingredients and carrying them into dry fire sprinkler systems. Various grades of filter media can be used, such as steel wool 302. Beads, fibers of wood or plastic, can also be used. Appertured plates 312 can also be used. The inner body 186 has an opening on the top for exiting of the vapors, and a slotted opening on the bottom for entrance of the air and/or product. The pressure pushing the air down and into the bottom slots of the interior tube, forces the air through the slots and through the filter media and starts breaking down the air and the chemical product into smaller and smaller bubbles as it moves upward through the filter media. The smaller bubbles allow greater surface areas between air and chemical allowing maximum absorption between chemical and air. There could be a wetted filter with chemical and larger surface area allows for more vapor pick up in dried air. The air then exits of the inner body 186 and flows into the fire sprinkler system. The vapors coat the metal of the dry fire sprinkler system, and if water is present, dissolve into the water and coat the underwater metal stopping corrosion both above and below the water.

The corrosion inhibitor composition is comprised of one or more chemical product ingredients and may include an amine, a carboxylate, a carboxylate amine, and combinations thereof. In some aspects, the corrosion control composition may include a compound having the formula HN(CH₂CH₂OH)ₙ, where n is 1, 2, or 3. In some aspects, the corrosion inhibitor composition may include a primary amine, such as monoethanolamine. In some aspects, the corrosion inhibitor composition may include a secondary amine, such as morpholine. In some aspects, the corrosion inhibitor may include a tertiary amine, such as triethanolamine. In some aspects, the corrosion inhibitor composition may include a carboxylic acid, having the formula HOOC—(CH2)ₙ-COOH, wherein n is 0-13. In some aspects, the carboxylic acid is Undecanedioic Acid, Dodecanedioic Acid, Neodecanoic acid, Sebacic acid, C4-C9 Dibasic Acids, or Other Dibasic Acids. In some aspects, the corrosion inhibitor composition may include a combination of monoethanolamine, morpholine, triethanolamine, and/or Neodecanoic acid. In some aspects, the corrosion inhibitor composition may include heterocyclic compound. In some aspects, the heterocyclic compound may include a heterocyclic alkyl and an amine. In some aspects, the heterocyclic compound may have the formula R—(C₆H₄)—N₂NH, wherein R is hydrogen or a C₁-C₁₀ alkyl. In some aspects, the heterocyclic compound may include benzotriazole. In some embodiments, the corrosion inhibitor composition may include tolytriazole. In some aspects, the corrosion inhibitor composition may include water. In some aspects, the corrosion inhibitor composition may include benzotriazole and tolytriazole. In some aspects, the corrosion inhibitor composition may further include a diol, such as propylene glycol. In some aspects, the amine corrosion inhibitor may include any class of amines; including ammonia, primary amines, secondary amines, tertiary amines, cyclic amines, quaternary ammonium salts, and/or amino acids and zwitterions. In greater detail, amines may include:

Ammonia A compound of nitrogen and hydrogen with the formula NH₃. Contains zero carbons.

And, or: Primary amines—Primary amines arise when one of three hydrogen atoms in ammonia is replaced. These have two hydrogen atoms and one non-hydrogen group attached to the nitrogen to form the amine or amino group —NH₂. Important primary alkyl amines include methylamine, ethanolamine (2-aminoethanol), and the buffering agent tris, while primary aromatic amines include aniline. Additional primary amine examples include but are not limited to:
ALIPHATIC amines: methylamine (aminomethane), CH₅N; ethylamine (aminoethane), C₂H₇N; propylamine, (1-aminopropane), C₃H₉N; 2-aminopropane; butylamine, (1-aminobutane), C₄H₁₁N; 2-aminobutane; 1-aminopentane (pentylamine), C₅H₁₃N; 2-aminopentane; 3-aminopentane; 1-aminohexane (hexylamine), C₆H₁₅N; 2-aminohexane; 3-aminohexane. Examples of primary diamines: 1,2-diaminoethane, C₂H₈N₂; 1,3-diaminopropane, C₃H₁₀N₂; 1,4-diaminobutane, C₄H₁₂N₂; 1,5-diaminopentane,
C₅H₁₄N₂; 2,3-diaminopentane; 2,4-diaminopentane; 1,4-diaminohexane, C₆H₁₆N₂; 1,6-diaminohexane. Examples of primary cyclo-amines: e.g. cyclopentylamine; aminocyclopentane, C₅H₁₁N₂; aminocyclohexane; cyclohexylamine, C₆H₁₃N₂; benzylamine, C₇H₉N. AROMATIC amines, where the amino or amine group is directly attached to the aromatic benzene ring: e.g. phenylamine, C₆H₇N, C₆H₅NH₂; 1,3-diaminobenzene, C₆H₈N₂; 3-aminobenzoic acid; 2-methylphenylamine; methyl-2-phenylamine; 1-amino-2-methylbenzene. Many ‘amino acids’ are ‘primary’ amines.

And, or: Secondary amines —Secondary amines have two non-hydrogen groups, such as organic substituents (alkyl, aryl or both) bound to N together with one hydrogen (or no hydrogen if one of the substituent bonds is double).

Important representatives include dimethylamine and methylethanolamine, while an example of an aromatic amine would be diphenylamine. These have one hydrogen atom and two alkyl or aryl groups attached to the nitrogen. Additional secondary include but are not limited to:
ALIPHATIC amines: dimethylamine; ethylmethylamine; diethylamine; methylpropylamine; ethylpropylamine; dipropylamine. Examples of cyclo-secondary amines: e.g. piperidine, C₅H₁₁N; N-methylcyclopentylamine, C₆H₁₃N. AROMATIC amines: N-methylphenylamine, C₇H₉N; N-ethylphenylamine, C₈H₁₁N; and diphenylamine, C₁₂H₁₁N.

And, or: Tertiary amines—In tertiary amines, all three hydrogen atoms are replaced, such as by organic substituents.

Examples include trimethylamine, which has a distinctively fishy smell, or triphenylamine. These have no hydrogen atom and three alkyl or aryl groups attached to the nitrogen. Additional tertiary amines include but are not limited to:
ALIPHATIC amines: trimethylamine; ethyldimethylamine; diethylmethylamine; and triethylamine. Cyclo-tertiary amines: N-methylpyrrolidine, and N-methylpiperidine, Tertiary AROMATIC amines: N,N-dimethylphenylamine; N,N-diethylphenylamine; and triphenylamine

And, or: Cyclic amines—Cyclic amines are either secondary or tertiary amines.

Examples of cyclic amines include the 3-member ring aziridine and the six-membered ring piperidine. N-methylpiperidine and N-phenylpiperidine.

And, or: Quaternary ammonium salts—It is also possible to have four organic substituents on the nitrogen. These species are not amines but are quaternary ammonium cations and have a charged nitrogen center. Quaternary ammonium salts exist with many kinds of anions. If all for hydrogens of an ammonium ion are replaced, such as with alkyl or aryl groups, then an ionic quaternary salt is formed.

The simplest is tetramethylammonium chloride, (CH₃)₄N⁺Cl⁻; tetrapropylammonium chloride, (CH₃CH₂CH₂)₄N⁺Cl⁻; and the R groups can be mixed e.g. [(CH₃CH₂CH₂)₃NC₆H₅]⁺Cl⁻

And, or: Amino Acids and Zwitterions—The primary suffix name for an aliphatic carboxylic acid is based on the “longest carbon chain name *” for the —COOH bond system e.g. ethanoic acid, propanoic acid etc. The amino group —NH₂, with its C-atom position number, is added as a prefix. [* without the end ‘e’] Many amino-acids in aqueous solution, or in the crystalline state, exist as ‘zwitterions’ where the proton migrates from the acidic —COOH group to the basic —NH₂ group to form the ionic groups —NH₃⁺and —COO⁻BUT within the same ‘molecule’. Additional amino acids include but are not limited to: Aminoethanoic acid, C₂H₅NO₂; 2-aminopropanoic acid, C₃H₇NO₂; and 3-aminopropanoic acid.

In a range, the corrosion inhibitor composition may be prepared according to Table 1:

| | | | % by weight of Corrosion | |
|---|---|---|---|---|
| Component | Amount | | Control Composition | |
| A Primary Amine: | 0% to 100% | BW | 0% to 100% | BW |
| Monoethanolamine | | | | |
| A Secondary Amine: | 0% to 100% | BW | 0% to 100% | BW |
| Morpholine | | | | |
| A Tertiary Amine: | 0% to 100% | BW | 0% to 100% | BW |
| Triethanolamine | | | | |
| A Carboxylic Acid: | 0% to 50% | BW | 0% to 50% | BW |
| Neodecanoic acid | | | | |
| Benzatriazole | 0% to 100% | BW | 0% to 100% | BW |
| Tolytriazole | 0% to 100% | BW | 0% to 100% | BW |
| Propylene glycol | 0% to 80% | BW | 0% to 80% | BW |
| Water | 0% to 80% | BW | 0% to 80% | BW |

In a preferred embodiment, the corrosion inhibitor composition may be prepared according to Table 1:

| | | | % by weight of Corrosion | |
|---|---|---|---|---|
| Component | Amount | | Control Composition | |
| Monoethanolamine | 45% | BW | 45% | BW |
| Morpholine | 10% | BW | 10% | BW |
| Triethanolamine | 25% | BW | 25% | BW |
| Neodecanoic acid | 12% | BW | 10% | BW |
| Benzatriazole | 5% | BW | 3% | BW |
| Tolytriazole | 3% | BW | 2% | BW |
| Propylene glycol | <1% | BW | <1% | BW |
| Water | <1% | BW | <1% | BW |

The initial mix of Monoethanolamine, Morpholine, Triethanolamine and Neodecanoic acid may be combined with equal portions of Benzotriazole and Tolytriazole in the same proportional volume as the initial mix. Propylene glycol may be added to dilute the final mix to whatever consistency desired.

It should be understood that the following is a listing of the components shown FIG. 1 and they are shown simply by way of example and not by way of limitation:
By-Pass air line parts
   ByPass Valve sized to Plant air line
   Air line Tee reduced to ¾ inch going to and from Feed system
   ¾ inch nipple to air line tee
   ¾ inch valve shut off going to above nipple
   ¾ inch nipple to valve to feed system
   ¾ inch union
   ¾ inch nipple from union to Tee
   ¾ inch tee to nipple
   ¾ inch brass or steel corrosion plug on end of tee
   corrosion coupon
   ¾ inch nipple on end of Tee
   ½ inch male bushing to connect to ¾ female thread
De-watering SUNAMI—connects to above ½ inch bushing above.
   ½ inch×short nipple connecting dewaterer to deoiler
De-Oiler SUNAMI—connects to above ½ inch bushing above.
   ½ inch×short nipple connecting deoiler to union.
   ½ inch union
Desiccant System 5 inch×24 inch
   S. S. 5 inch×24 inch air filter
   1.5 inch male thd×½ inch female thd S. S. Bushing
   ½ inch×short nipple
   ¼ inch 316 L S. S. valve drain
   4.5 inch Blue PVC×20 inch internal casing tube
   10 lbs Desiccant material
   1.5 inch male thd×½ inch female thd S. S. Bushing
   ½ inch×short nipple
   ½×½×½ Tee
   ½ indicating site glass
   ½ inch×short nipple
   ½ valve
   ½ inch union
   5 inch×24 inch
Chemical aerator system
   ½ inch×short nipple
   1.5 inch male thd×½ inch female thd S. S. Bushing
   S. S. 5 inch×24 inch air filter
   4.5 inch Blue PVC×20 inch internal casing tube
   0000 aught steel wool filtering medium
   ¼ inch 316 L S. S. valve drain
   Gallon “ProGuard Air”
   1.5 inch male thd ×½ inch female thd S. S. Bushing
   ½ inch×short nipple
   ½×½×½ inch S. S. Tee
   ½inch boiler valve (2 each)
   ½ to ¾ inch expanding bushing
   ¾ inch×short nipple
   ¾×¾×¾ inch Tee
   corrosion coupon
   ¾ corrosion coupon plug
   ¾ inch nipple on top end of Tee
   ¾ inch union
   ¾ inch nipple to valve to feed system
   ¾ inch valve shut off going to above nipple
   ¾ inch nipple to air line tee
   Air line Tee reduced to ¾ inch going to and from Feed system
      In order to chemically treat the fire sprinkler system, the operator closes the OS&Y (“outside stem and yoke”) or control valve and then drains the system. The drain (not shown), is located in the downstream portion of the fire sprinkler system. This permits all of the air in the fire sprinkler system to be evacuated. The drains are then closed and the two ball valves are then opened, which permits the air to flow through the corrosion inhibition system.

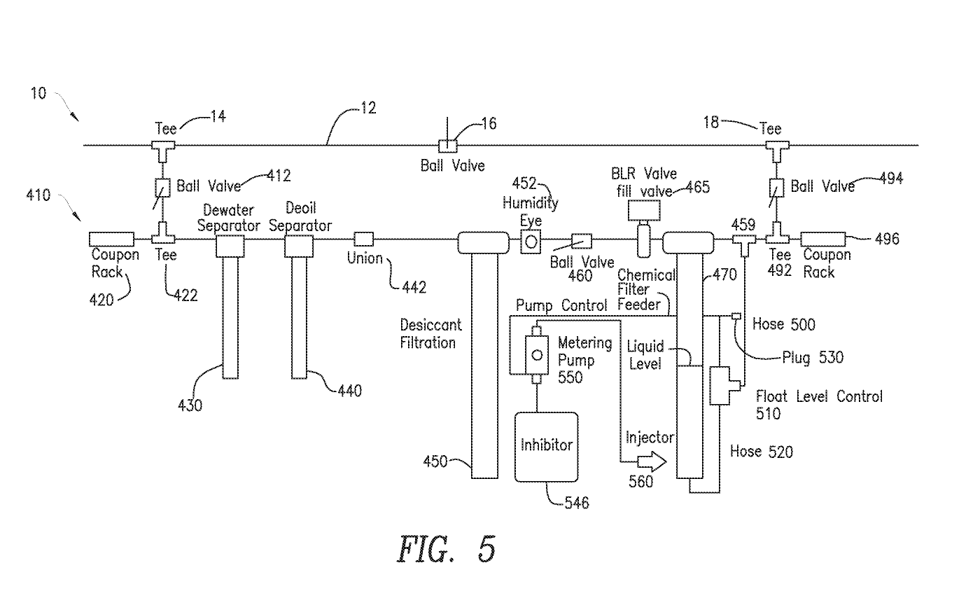

Referring to FIG. 5, another aspect of the corrosion inhibitor system 410 is shown. The corrosion inhibitor system 410 is interconnected with the fire sprinkler system 10 by tee 14 through valve 412 to tee 422, and includes a first coupon rack 420, a dewater separator 430, deoil separator 444), union 442, desiccant filtration apparatus 454), humidity eye 552, filtration ball valve 460, fill valve 465, filter feeder apparatus 470, fourth tee 492, output ball valve 494 and second coupon rack 496.

The corrosion inhibitor system 410 is connected back to the dry fire sprinkler system 10 at second tee 18. The system 410 further includes a tee 499, such as a two inch mechanical tee, with a hose 500 to float level control 510, such as a magnetic float switch, for turning a chemical metering pump on and off. Float level control 510 receives power from plug 530 and is connected by hose 520 to the filter feeder apparatus 470. A metering pump 554), such as a four gallon per day metering pump, also receives power from plug 530 and is connected to a tank 540, such as a five gallon container, of the corrosion inhibitor chemical ingredients and can inject the chemical ingredients into the feeder apparatus 470 through injector 560 based on feedback from the float level control 510. This allows for automatic control and maintenance of the chemical level in the feeder apparatus 470.

The Fire Sprinkler Corrosion Monitoring Station (FSCMS) can be installed on the system riser or on a main connected to the riser to monitor internal corrosion conditions in a water based fire protection system. The Fire Sprinkler System can be continuously monitored so that activities such as filling and draining are also experienced by the FSCMS. In buildings where more than one fire sprinkler system being fed from a common riser, the FSCMS can be installed on the system side of the control valve on each of the individual systems. The FSCMS is designed to simulate conditions where internal corrosion may develop within the system. The FSCMS can be safely isolated from the system riser or main and easily accessed for servicing and monitoring of test specimens, (corrosion coupons or corrosion monitoring probes) without taking the fire protection system out of service. Corrosion coupons can be installed in the corrosion monitoring station by the use of a di-electric coupon holder.

The corrosion monitoring station can be provided as two components, to allow for quick installation. The main assembly could include the corrosion monitoring station with ball valve. The second component could include the dielectric coupon holder. The procedure for the installation of the corrosion monitoring station can be as follows:

A 1″ NPT connection into the sprinkler system riser or supply main is provided as may be detailed by the designer.

2. The threaded nipple closest to the bail valve is screwed into the 1″ NPT connection to the system. Teflon tape and/or PTFE paste may be used on this threaded connection. The FSCMS is positioned in a vertical format where the dielectric coupler is at the bottom of the assembly.

The corrosion monitoring station should not be installed in any configuration that could cause trapped water within the unit or the piping to the unit that will not drain when draining the fire sprinkler system.

Wet Fire Sprinkler Placement Steps for FSCM Service:

1. Star with the FSCMS ball valve in the closed position.

2. Remove the di-electric coupon holder slowly to release any remaining pressure from the coupon holder.

3. Once the di-electric coupler is removed, connect the coupon sample to the wand with the holding screw.

4. Apply Teflon tape to the threaded portion of the di-electric coupler.

5. Thread the di-electric coupler back into the corrosion monitoring station.

6. Slowly open the isolation ball valve to fill the chamber with water. Leave the ball valve in the open position so system water floods the assembly.

It should be verified that all valves are in the correct position and the corrosion monitoring station is free of any leaks.

While the invention has been described in detail and with reference to specific examples thereof, it will be apparent to one skilled in the art that various changes and modifications can be made therein without departing from the spirit and scope thereof.

What is claimed is:

1. A corrosion inhibitor system for a dry fire sprinkler system comprising:
an air dryer;
a corrosion inhibitor;
mixer for mixing the corrosion inhibitor with air; and
a valve positioned between the mixer and a dry fire sprinkler system.

2. The system of claim 1 wherein the mixer comprises an outer body and an inner body housing a filter media.

3. The system of claim 2 wherein the inner and outer bodies are cylindrical and there is a space between the bodies for air flow.

4. The system of claim 3 wherein the filter media comprises metal mesh.

5. The system of claim 4 wherein the metal mesh comprises steel mesh.

6. The system of claim 4 wherein the corrosion inhibitor comprises an amine, a carboxylate, and a carboxylate amine.

7. The system of claim 4 wherein the corrosion inhibitor comprises monoethanolamine, morpholine, triethanolamine, neodecanoic acid, benzotriazole, tolytriazole, propylene glycol, water or combinations thereof.
